(19) United States
(12) Patent Application Publication
(10) Pub. No.: US 2002/0067831 A1
(43) Pub. Date: Jun. 6, 2002

(54) IP-based architecture for mobile computing networks

(75) Inventors: John Zhu, San Diego, CA (US); Michele Ann Jannette, Cardiff, CA (US)

Correspondence Address: John L. Rogitz, Rogitz & Associates, 750 B Street, Suite 3120, San Diego, CA, 92101, US

(73) Assignee: SONY CORPORATION, Tokyo (JP)

(21) Appl. No.: 09/840,954

(22) Filed: Apr. 24, 2001

Related U.S. Application Data
(60) Provisional application No. 60/251,743, filed on Dec. 5, 2000.

(51) Int. Cl. H04K 1/00

(52) U.S. Cl. 380/272; 380/270

(57) ABSTRACT

A wireless broadband IP network with a data transfer rate in excess of one megabyte per second for providing up to the minute subscription services to mobile client devices. The network has a network operation center (NOC) and base stations communicating with respective data centers and with mobile client devices. As a mobile client device moves from the area of one base station to another, the provision of subscription services to the device is handed off from one base station to the next without interruption.

### RELATED APPLICATIONS

This application claims priority from U.S. provisional patent application serial No. 60/251,743, filed Dec. 5, 2000.

### BACKGROUND OF THE INVENTION

1. Field of the Invention

The present invention relates generally to wireless Internet Packet (IP) communication systems.

2. Description of the Related Art

Networked computing is a powerful tool for business and personal use. With it, the user of a user terminal that communicates with a network such as a company's local area network (LAN) can access and share data with other terminals in the network.

Most LANs are implemented by wired connections, i.e., by requiring that the computers in a network be attached to the network by means of wires. For convenience and to permit easy movement of user terminals within the network, wireless networks have been introduced, in which network communication is established via a wireless radiofrequency (rf) or infrared (IR) link.

As recognized by the present invention, a wireless communication network can be established using Internet Packet (IP) data format principles. In this way, data that is formatted for the Internet can be directly transmitted between a sender and a receiver. However, as also recognized herein, existing IP systems do not have a capability to continue to provide communication in a single session as a mobile device travels between base stations. This is referred to as “handoff” in wireless telephony but facilitating such handoff is not trivial in the context of wireless IP packetized communications.

The present invention understands that the inability to handoff a communication session between base stations renders such networks less than optimum for providing subscription services, such as wireless Internet subscription services, to mobile client devices. Without the ability to handoff a session, the provision of services can be interrupted as the client moves, requiring time to reestablish the data stream, a frustrating experience. Digital telephone systems, on the other hand, cannot easily be used for purposes of the present invention because, as understood herein, such systems have bandwidths that are too narrow to support broadband services as contemplated herein. Having recognized the above-noted problem, the present invention provides the solution disclosed herein.

### SUMMARY OF THE INVENTION

An Internet packet (IP) mobile wireless communication system includes a network operation center (NOC) that has one or more application components. Link terminals communicate with client devices in the system and receive IP packets therefrom in respective sessions. The IP packets are associated with information that is unique to the session, and each session is encrypted with a unique session secret that is shared between a client device and a link terminal communicating with the device. As set forth in greater detail below, the information is useful in providing data from the application component in IP packet format to a client device moving relative to the link terminals by providing at least one IP packetized data stream to the client device using a first link terminal and then continuing to provide the data stream to the client device from a second link terminal as the client device moves.

In a preferred non-limiting embodiment, a respective data center incorporates each link terminal, and a respective base station is associated with each data center. Also, the link terminal of a session generates the shared secret. Moreover, the information is a session name, and the session name is generated by the local link terminal. The link terminal strips the session name from messages from a client device. If desired, the data from the application component can be a subscription service the content of which can be tailored to the location of the client device.

Each client device includes a directional antenna and an IP transceiver electrically coupled to the antenna for communicating with the base stations and, hence, with the link terminals at the associated data centers. The preferred system has a data transmission rate between a client device and a link terminal in excess of one megabyte per second.

In another aspect, a mobile wireless IP-based communication network for providing up to the minute subscription services to client devices includes a network operation center (NOC) and base stations communicating with the NOC. The base stations are in wireless communication with client devices communicating with the network. In accordance with this aspect, the NOC provides subscription services in IP format to a client device via at least one base station in a session. In this aspect, the base station receives messages including IP packets and a unique session name from a client device, and the messages are encrypted with a shared secret. The network permits the client device to roam around the network in the midst of the session substantially without interruption of the session.

In yet another aspect, a method for providing subscription services to client devices via a wireless IP network includes sending an IP-packetized data stream to a first link terminal, and providing the data stream to a wireless client device that is in wireless IP communication with the first link terminal. As the client device moves away from the first link terminal toward a second link terminal, the data stream is handed off from the first link terminal to the second link terminal, such that the data stream is then provided to the client device via the second link terminal. The handoff is very quick, preferably on the order of a few nanoseconds, so that it appears to the client device that the session is not interrupted.

The details of the present invention, both as to its structure and operation, can best be understood in reference to the accompanying drawings, in which like reference numerals refer to like parts.

### BRIEF DESCRIPTION OF THE DRAWINGS

FIG. 1 is a schematic diagram showing the system architecture of the present invention;

FIG. 2 is a flow chart showing the session establishing logic; and

FIG. 3 is a flow chart showing the handoff logic.

### DETAILED DESCRIPTION OF THE PREFERRED EMBODIMENTS

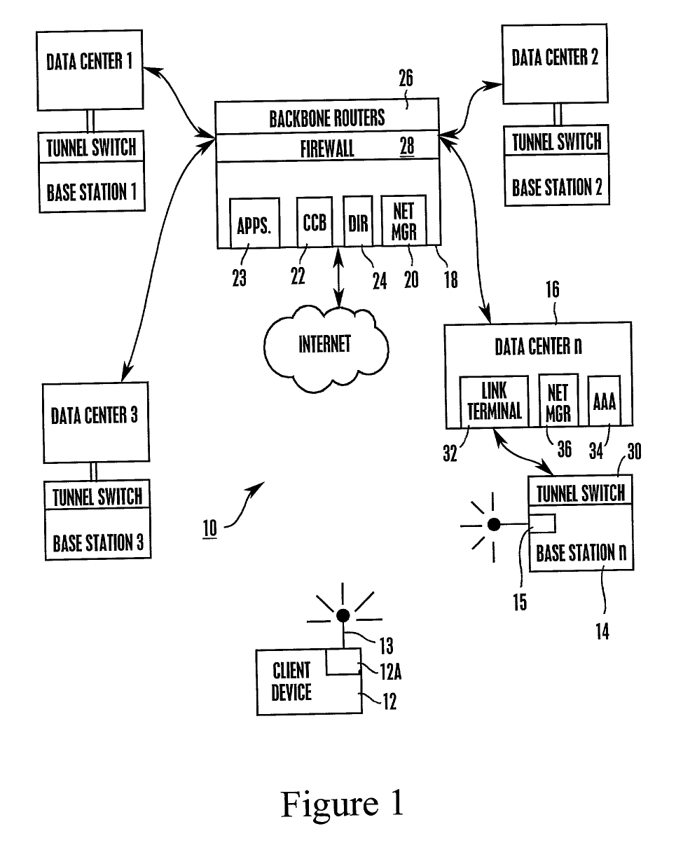

Referring initially to FIG. 1, a system is shown, generally designated 10, that includes plural mobile client devices or computers 12 (only a single device 12 shown for clarity) that are in wireless communication with one or more substantially identical, geographically separated base stations 14 of a wireless network for one or more functions, including but not limited to the provision of subscription services to the client devices 12 and to facilitate client-to-client communication. In one non-limiting embodiment, the network can have a broadband Internet packet (IP) data protocol, such as an i-Burst network made by Arraycomm. Such a network can use space division multiple access (SDMA) directional communication principles and has a data transfer rate in excess of one megabyte per second, operating in a non-limiting, exemplary frequency of between two thousand three hundred million Hertz and two thousand three hundred ten million Hertz (2300 mHz-2310 mHz).

The client device 12 includes an IP transceiver 12A with associated directional antenna 13. Each base station 14 likewise has a broadband IP transceiver 15. In turn, each base station 14 communicates with a respective data center 16 via wired or wireless communication paths, with the data centers 16 communicating with a network operation center (NOC) 18 via wired or wireless communication paths. The NOC 18 can be connected to the Internet.

The data centers 16 are substantially identical to each other. Accordingly, the disclosure below focusses on the n^{th} base station 14 and associated nth data center 16, it being understood that the discussion below applies equally to all base stations and data centers. It is to be further understood that while the base stations 14 are shown separate from the data centers 16, the two system components can be combined into a single component. Likewise, if desired the data centers 16 can be incorporated into the NOC 18. Thus, FIG. 1 shows one particularly preferred architecture.

The client device 12 can be any suitable portable device or PC. For example, the client device 12 can be a laptop or palmtop computer, or other network appliance, that contains a processor for executing the client-side logic herein. Likewise, the computers of the data centers 16, NOC 18, and base stations 14 can be portable computing devices, PCs, mainframe computers, or can themselves be networks of computers.

The flow charts herein illustrate the structure of a logic device of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer) to perform a sequence of function steps corresponding to those shown. Internal logic could be as simple as a state machine.

In other words, the present logic may be established as a computer program that is executed by a processor as a series of computer-executable instructions. In addition to residing on hard disk drives, these instructions may reside, for example, in RAM of the appropriate computer, or the instructions may be stored on magnetic tape, electronic read-only memory, or other appropriate data storage device.

In greater detail with respect to the architecture of FIG. 1, the NOC 18 includes a network manager component 20, a customer care and billing (CCB) 22, one or more application components 23, and one or more directories or databases 24. Also, one or more backbone routers 26 can be behind a communication firewall 28. The components 20, 22, 23, 24, and 26 can be implemented by separate computers or by one computer.

In one non-limiting example, the network manager component 20 provides for monitoring the status of the network, including a database of authorized clients, types of software being used, operational status of the network, and so on. It can be a network manager component made by, e.g., Nortel, Hewlett-Packard, or Tivoli, although other types of network managers can be used.

In another non-limiting example, a conventional telephony or utility usage and billing computer can be used to establish the CCB component 22. For instance, an AMDOCS billing and usage computer can be used. The CCB component 22 tracks client usage of the network such that clients can be billed based on, e.g., air time, or on the number of IP packets communicated by the client over the network.

In still further non-limiting examples, the application components 23 can be integrated or separate computers for providing respective services to client devices 12. For instance, one application component 23 can be a game application component, another can be a music application component, still another can be a video application component. The directory or database 24, on the other hand, contains network information such as but not limited to client type and status information.

In a further non-limiting exemplary embodiment, the backbone routers 26 can be established by conventional IP packet router computers. While one non-limiting function of the system 10 is to provide subscription services by, e.g., providing applications from the application components 23 to the client devices 12, another function can be to permit a client device near one base station 14 to communicate directly with a client device near another base station, and the backbone routers 26 can be used for this purpose, bypassing one or more of the remainder of the NOC 18 components if desired.

Turning now to the base stations 14 and associated data centers 16, each base station 14 includes a respective tunnel switch 30 that interfaces with the associated data center 16. The tunnel switch can be a conventional tunnel switch made by, e.g., Lucent, Nortel, or Cisco but that transmits packets in accordance with the disclosure below for permitting client handoff between base stations 14 when the client 12 is moving. IP packets received from a wireless mobile client device 12 are sent from the tunnel switch 30 of a base station 14 to a link terminal 32 of the associated data center 16.

The link terminal 32 can be a L2TP-type router that collects IP packets and, programmed with the present logic, strips the below-described session name from them, leaving only IP headers with associated data. Also, each data center 16 includes a respective agent component 34 that contains authentication, authorization, and accounting information, client registry information, and so on or that accesses such information from the central directory or database 24 at the NOC 18. That is, the authentication, authorization, and accounting (AAA) agents 34 of the data centers 16 communicate with the central directory or database 24 to grant or deny client devices 12 access to the network and/or services thereon. In a non-limiting example, the agent component 34 can be established by a conventional IP packet router computer programmed in accordance with the logic discussed herein.

As contemplated by one implementation, client devices are assigned a “home” data center which contains all log-in and other AAA-related information on the client. More particularly, each client device 12 to which it is desired to give network access is assigned a respective IP address and is registered at a “home”-designated one of the data centers 16. Registration can include device type, owner identification and profile, and billing information. This client information is stored at the home data center 16. In such an implementation, the name of the client device can include the name of the home data center, e.g., “client@datacenter.n” would be the name of a client having the nth data center assigned as its home site.

As shown in FIG. 1, each data center 16 can also have components that are analogous to those of the NOC 18. Specifically, each data center 14 can include a network manager component 36 as well as other components, such as but not limited to other routers. The data center components can be implemented in separate computers or in a single computer. In any case, the network manager component 36 can include a database of client devices, software types being used, and local network status, including management information blocks (MlBs) and database updates.

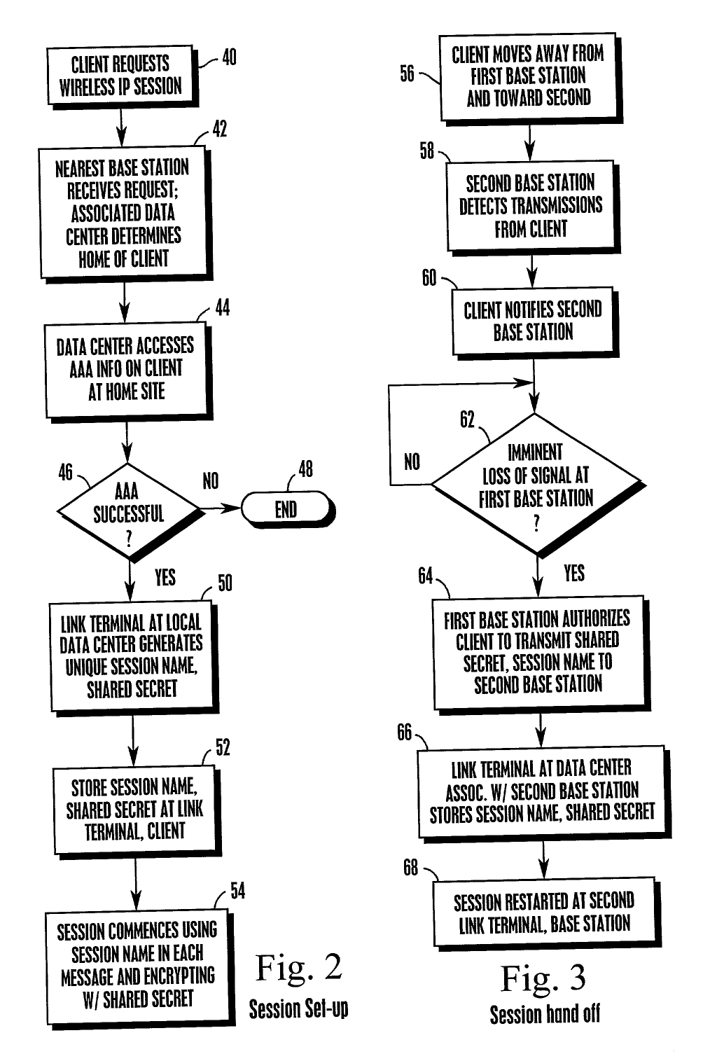

FIG. 2 illustrates one preferred non-limiting embodiment of the present session establishing logic. When a mobile client device 12 wishes to communicate with the network, it sends a client request for wireless IP access at block 40 of FIG. 2. The data center 16 of the nearest base station 14 or of the base station 14 receiving the strongest client device 12 signal at block 42 recognizes the signal from the client device, if not the precise identity of the client. In other words, when the requesting client device is a “foreign” device as to the particular data center 16 with which it is communicating, network routing and communication nevertheless are provided, since the client's home data center can be determined from the client name, as set forth above.

Moving to block 44, the receiving data center 16 accesses MA information at its own agent component 34, if the receiving data center is the home of the requesting client device, or it accesses MA information from the home data center via the backbone routers 26 at the NOC 18. Alternatively, AAA information can be obtained directly from the directory 24 of the NOC 18.

At decision diamond 46 it is determined whether the AAA operation was successful, i.e., whether the client device was successfully authenticated and authorized. If not, the logic ends at state 48, but if the client device successfully logged on to the network, the logic flows to block 50.

At block 50, the link terminal 32 at the receiving (i.e., local relative to the client) data center 16 generates a unique session name and session shared secret. The shared secret can be a randomly generated encryption code for use in, e.g., a public key-private key encryption system. Both the session name and shared secret are stored, at block 52, at the link terminal 32 of the local data center 16 and at the client device 12. At block 54, the session commences and is executed using the session name in, e.g., each message and encrypting each message using the shared secret.

Executing the session can include providing subscription content from the NOC 18 as mentioned above, including subscription service tailored to the location of the client device such as restaurant and movie guides, weather, etc. A session can also include providing client-to-client communication via the backbone routers 26 at the NOC 18. As discussed above, IP packets from the client device 12 are stripped of the session name by the link terminal 32 prior to forwarding the packets to the recipient, e.g., the NOC 18 or another client device.

FIG. 3 illustrates one preferred non-limiting embodiment of the present handoff logic. In FIG. 3, reference to “first” base station pertains to the local base station 14/data center 16 discussed in FIG. 2, and reference to “second” base station pertains to a base station 14/data center 16 other than the first base station. Since the client device 12 is mobile, it can move away from the first base station 14 and toward a second base station 14 at block 56 in the middle of a session. If desired, at block 58 the second base station can detect transmissions from the client device 12, and/or at block 60 the client device 12 can notify the second base station 14 that the client device 12 is entering the area of the second base station 14.

In any case, at decision diamond 62 the first base station 14 determines whether a loss of signal from the moving client device 12 is imminent. When this test evaluates to true, the logic proceeds to block 64, wherein the first base station authorizes the client device 12 to transmit to the second base station the session shared secret and, if not already done, to transmit the session name. At block 66, these pieces of information are stored by the link terminal 32 of the data center 16 that is associated with the second base station 14. The session is then restarted at the second base station 14/data center 16 at block 68, and the session continued, seemingly without interruption, using the session name and shared secret.

In undertaking the above process, certain additional actions can be taken if desired. For instance, at handoff time the second base station 14/data center 16 ordinarily configures its router switch to send messages to the recipient identified in the messages from the client 12, using the same session name and shared secret. In this way, the session is restarted but in a period of nanoseconds, making the handoff transparent to the client device 12.

While the particular IP-BASED ARCHITECTURE FOR MOBILE COMPUTING NETWORKS as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

What is claimed is:

1. An Internet packet (IP) mobile wireless communication system, comprising:
at least one network operation center (NOC) including at least one application component; and
plural link terminals communicating with plural client devices and receiving IP packets therefrom in respective sessions, at least some IP packets being associated with information unique to the session, each session being associated with a unique shared secret between a client device and a link terminal communicating therewith, the information being useful in providing data from the application component in IP packet format from the NOC to a client device moving relative to the link terminals by providing at least one IP packetized data stream to the client device using a first link terminal and then continuing to provide the data stream to the client device from a second link terminal as the client device moves.

2. The system of claim 1, further comprising a respective data center incorporating each link terminal.

3. The system of claim 2, further comprising logic at at least one local link terminal for generating the shared secret.

4. The system of claim 3, wherein the information is at least one session name, and the session name is generated by the local link terminal.

5. The system of claim 2, further comprising a respective base station associated with each data center.

6. The system of claim 4, further comprising logic at the local link terminal for stripping the session name from messages from a client device.

7. The system of claim 1, wherein a location of at least one client device is tracked and subscription services provided thereto based at least partially on the location.

8. The system of claim 1, wherein each client device includes a directional antenna and an IP transceiver electrically coupled to the antenna for communicating with at least one link terminal.

9. The system of claim 1, wherein the system has a data transmission rate between a client device and a link terminal in excess of one megabyte per second.

10. A mobile wireless IP-based communication network for providing up to the minute subscription services to client devices, comprising:
at least one network operation center (NOC); and
plural base stations communicating with the NOC and in wireless communication with client devices communicating with the network, the NOC providing at least one subscription service in IP format to at least one client device via at least one base station in at least one session, the base station receiving messages including IP packets and at least one unique session name from at least one client device, the messages being encrypted with a shared secret, the network permitting the client device to roam around the network in the midst of the session substantially without interruption thereof.

11. The network of claim 10, wherein a location of at least one client device is tracked and subscription services provided thereto based at least partially on the location.

12. The network of claim 10, wherein the network has a data transmission rate between a client device and a base station in excess of one megabyte per second.

13. The network of claim 10, wherein each base station is associated with a respective data center incorporating a respective link terminal, the link terminals communicating with the client devices and receiving IP packets therefrom in respective sessions, such that at least one IP packetized data stream can be provided to a client device using a first link terminal and then provision of the data stream to the client device can be undertaken from a second link terminal as the client device moves.

14. The network of claim 13, wherein the session names and shared secrets are generated by the link terminals.

15. The network of claim 13, wherein a link terminal strips the session name from messages from a client device.

16. The network of claim 10, wherein a location of at least one client device is tracked and subscription services provided thereto based at least partially on the location.

17. The network of claim 10, wherein each client device includes a directional antenna and an IP transceiver electrically coupled to the antenna for communicating with at least one base station.

18. A method for providing subscription services to client devices via a wireless IP network, comprising:
sending at least one IP-packetized data stream to at least a first link terminal;
providing the data stream to at least one wireless client device in wireless IP communication with the first link terminal; and
as the client device moves away from the first link terminal toward a second link terminal, handing off the data stream from the first link terminal to the second link terminal, such that the data stream is provided to the client device via the second link terminal.

19. The method of claim 18, wherein the data stream is associated with a session and the method includes associating the session with a unique session name generated by the first link terminal.

20. The method of claim 19, further comprising encrypting at least portions of the session using a unique session shared secret generated by the first link terminal.

21. The method of claim 20, further comprising stripping away the session name at the first or second link terminal from messages received from the client device.

22. The method of claim 18, further comprising providing the data stream at a transfer rate of in excess of one megabyte per second.

23. The method of claim 18, wherein the data stream is at least one subscription service.

24. The method of claim 23, wherein the service contains information tailored to the location of the client device.

25. The method of claim 20, wherein the session name and shared secret are sent to the client device and stored thereat.

26. The method of claim 18, further comprising generating accounting data associated with the client device based on a number of IP packets provided thereto, or a time period the client device communicated with the link terminals, or both.

27. The system of claim 1, further comprising generating accounting data associated with the client device based on a number of IP packets provided thereto, or a time period the client device communicated with the system, or both.

28. The network of claim 10, further comprising generating accounting data associated with the client device based on a number of IP packets provided thereto, or a time period the client device communicated with the network, or both.

29. The system of claim 4, wherein the session name and shared secret are sent to the client device and stored thereat.

30. The network of claim 10, wherein the session name and shared secret are sent to the client device and stored thereat.
